(19) United States
(12) Patent Application Publication
(10) Pub. No.: US 2023/0121942 A1
(43) Pub. Date: Apr. 20, 2023

(54) ACCESSIBILITY WITHIN ENCLOSURES OF COMPUTING DEVICES

(71) Applicant: HEWLETT-DEVELOPMENT COMPANY, L.P., Spring (US)

(72) Inventors: Yao-Wen Fan, Taipei City (TW); Yu-Wei Tan, Taipei City (TW); Jia-Hung Lai, Taipei City (TW); Yi-Hsieh Chiu, Taipei City (TW)

(73) Assignee: HEWLETT-PACKARD DEVELOPMENT COMPANY, L.P., Spring, TX (US)

(21) Appl. No.: 17/914,463

(22) PCT Filed: Mar. 27, 2020
(86) PCT No.: PCT/US2020/025300

§ 371 Date: Sep. 26, 2022

(51) Int. Cl. G06F 1/16; G06F 1/18; G06F 1/20

(52) U.S. Cl. CPC G06F 1/1656; G06F 1/181; G06F 1/206

(57) ABSTRACT

Examples disclosed herein provide an enclosure of a computing device. One example enclosure includes a cover to provide access to components within the enclosure, and the cover is coupled to the enclosure via a shape memory material (SMM) structure. As an example, the SMM structure is to provide for removability of the cover according to a temperature of a heat generating component disposed within the enclosure.

### BACKGROUND

The emergence and popularity of computing has made computing devices a staple in today's marketplace. Examples of computing devices include desktop computers and notebook computers, which may have a compact design and lighter weight compared to desktop computers. Irrespective of the different form factors, the basic components of notebook computers may function identically to their desktop counterparts. Example components that may be housed in a computing device, for example, within an enclosure, include the motherboard, which may be a printed circuit board (PCB) with a microprocessor, such as the central processing unit (CPU), memory, bus, and other electronic components. In addition to the motherboard, other components housed within the enclosure may include the power supply and disk storage, which may include hard disk drives, solid state drives, and optical disc drives. At times, access may be made within the enclosure of the computing device, for example, to inspect or replace certain components, if they are faulty or need to be upgraded. As an example, the enclosure of the computing device may include a removable cover that provides access to the components.

### BRIEF DESCRIPTION OF THE DRAWINGS

FIGS. 1-2 illustrate an enclosure of a computing device, with a removable cover to provide access to components within the enclosure, according to an example;

FIG. 3 illustrates a portion of another enclosure of a computing device, with a removable cover to provide access to components within the enclosure, according to an example; and

FIGS. 4-5 illustrate adjustments made to the SMM structure according to a temperature within the enclosure, according to an example.

### DETAILED DESCRIPTION

Examples disclosed herein provide the ability to control access to the components within an enclosure of a computing device, according to an example.

As mentioned above, the enclosure may include a removable cover that can provide access to the components. As will be further described, mechanical structures may either allow for the removability or prevent the removability of the cover, based on a temperature within the enclosure, for example, a system temperature or the temperature of a heat generating component, such as the CPU. As computing devices are utilized to perform complex operations, the components within the enclosure of the computing device may generate heat to a degree that is not safe for users to handle. As a result, when such temperatures are reached, the mechanical structures may prevent the removability of the cover. However, when the temperature falls below, for example, a threshold value, the mechanical structures may allow for the removability of the cover, for example, to inspect or replace certain components in the enclosure of the computing device. As an example, the mechanical structure for controlling access to the components within the enclosure may correspond to shape memory material (SMM) that adjusts, based on the temperature within the enclosure.

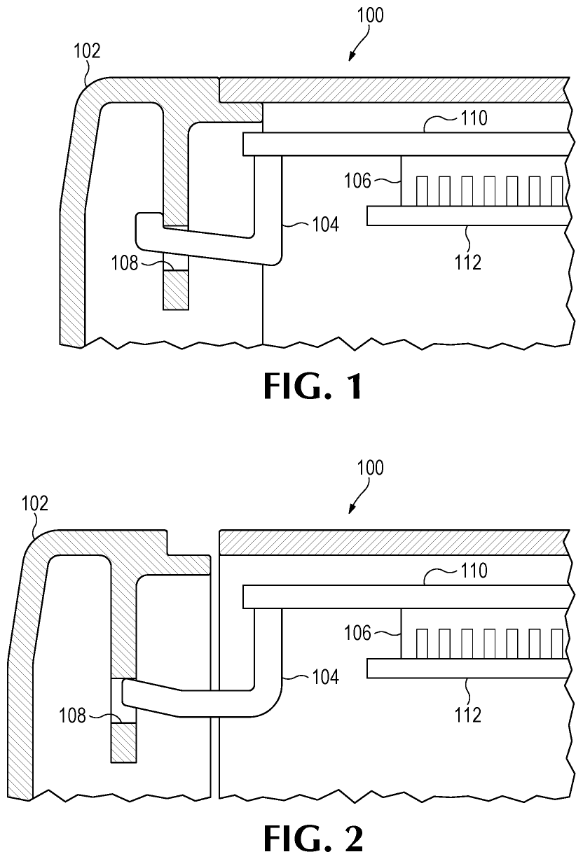

With reference to the figures, FIG. 1 illustrates an enclosure 100 of a computing device, with a removable cover 102 to provide access to components within the enclosure 100, according to an example. As will be further described, the cover 102 may be coupled to the enclosure 100 via SMM structures 104, and the SMM structures 104 may provide for removability of the cover 102 according to a temperature within the enclosure 100. As an example, the computing device may correspond to a desktop computer or the base member of a notebook computer, among others. As an example, the temperature within the enclosure 100 may be determined by a heat generating component 106, such as a CPU, disposed within the enclosure 100, coupled to a printed circuit board (PCB) 112.

With regards to a CPU, the current processing load of the CPU may determine the temperature of the heat generating component 106. For example, if the current processing load of the CPU is low, the temperature of the heat generating component 106 may fall below a threshold value. However, when the processing load of the CPU is high, the temperature of the heat generating component 106 may exceed the threshold value. In addition, rather than relying on a temperature threshold value to determine the processing load of the CPU, whether the temperature of the CPU falls within a lower range or higher range may provide an indication of whether the processing load of the CPU is low or high, respectively. As mentioned above, the SMM structure 104 may adjust according to the temperature within the enclosure 100, to provide for accessibility within the enclosure 100. As an example, when the temperature of the heat generating component 106 is to exceed the threshold value, the SMM structure 104 may prevent removability of the cover 102. In addition, when the temperature of the heat generating component 106 is to fall back below the threshold value, the SMM structure 104 may allow for removability of the cover 102.

Shape memory material (e.g., SMM structure 104) have the ability to return from a deformed state (e.g., temporary shape) to their original shape (e.g., permanent) induced by an external stimulus (trigger), such as a temperature change. For example, the shape memory material remembers its original shape and, when deformed, returns to its pre-deformed shape when heated. In addition to temperature change, the shape change of shape memory material can also be triggered by an electric or magnetic field, light, or solution. Shape memory material is a solid-state alternative to actuators, such as hydraulic, pneumatic, and motor-based systems. As a result, by using SMM structure 104, electromechanical features, which can increase the cost and complexity of computing devices, can be avoided.

Examples of shape memory material (e.g., SMM structure 104) include copper-aluminum-nickel and nickel-titanium (NiTi) alloys. However, shape memory material can be created by alloying zinc, copper, gold, and iron. In addition, non-metal shape memory materials, such as ceramic material and organic polymer shape memory material, can be used for shape memory material. As an example, NiTi based shape memory material provide stability and superior thermo-mechanic performance. NiTi alloys change from austenite to martensite upon cooling. Mf is the temperature at which the transition to martensite completes upon cooling. Accordingly, during heating Aₛ and A_{f} are the temperatures at which the transformation from martensite to austenite starts and finishes. As a result, SMM structure 104 can remember two different shapes, one at low temperatures, and one at the high temperatures, as will be further described. However, additional transformations of the SMM structure 104 is possible. In addition, the number of SMM structures 104 may vary, in order to couple cover 102 to the enclosure 100 of the computing device.

Referring to FIG. 1, the cover 102 includes a slot 108 to accommodate the SMM structure 104. As an example, the number of slots 108 may correspond to the number of SMM structures 104 for coupling the cover 102 to the enclosure 100 of the computing device. As an example, when the temperature of the heat generating component 106 exceeds the threshold value or is at a higher temperature, indicating that the processing load of the CPU may be high, accessibility within the enclosure 100 may not be desirable, for example, to avoid user injury. As a result, a shape of the SMM structure 104 may adjust within the slot 108 over the cover 102 to prevent removability of the cover 102. As illustrated, adjustment of the SMM structure 104 may include deformation along an end of the SMM structure 104 to lock the cover 102 to the enclosure and prevent removability. However, when the temperature of the heat generating component 106 falls back below, or is below the threshold value, or at a lower temperature like room temperature, indicating that the processing load of the CPU may be low, the SMM structure 104 may adjust to allow for removability of the cover 102, as illustrated in FIG. 2. As an example, the adjustment may include a removal of the deformation along the end of the SMM structure 104, thereby allowing the cover 102 to be removed from the enclosure 100.

As an example, the enclosure 100 of the computing device includes a thermally conductive component 110, such as a heat pipe, coupling the heat generating component 106 and the SMM structure 104. As a result, heat generated by the heat generating component 106 may transfer to the SMM structure 104 via the heat pipe 110, triggering the resulting shape change of the SMM structure 104, as described above. For example, if the temperature of the heat generating component 106 is to fall below the threshold value (e.g., processing load of CPU is light), the SMM structure 104 may adjust to allow for removability of the cover 102 (e.g., see FIG. 2). However, when the temperature of the heat generating component 106 exceeds the threshold value (e.g., processing load of CPU is high), the SMM structure 104 may adjust to prevent removability, once the heat generated by the heat generating component 106 is transferred to the SMM structure 104 via the heat pipe 110, thereby preventing a user from accessing components within the enclosure 100.

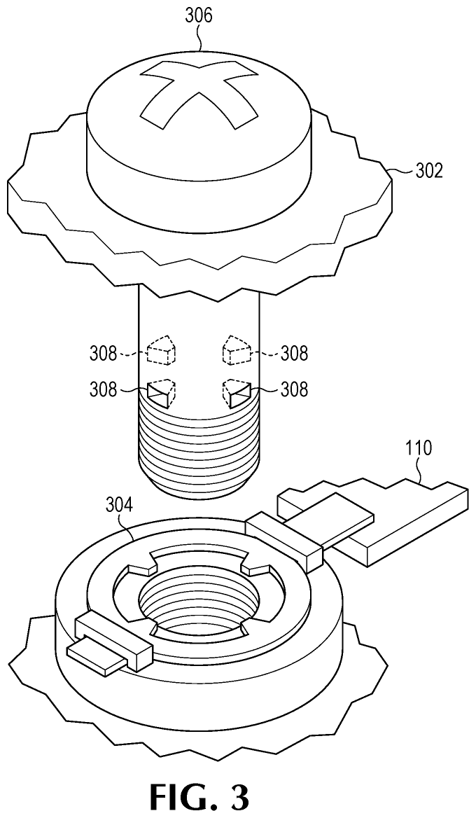

FIG. 3 illustrates a portion of another enclosure of a computing device, with a removable cover 302 to provide access to components within the enclosure, according to an example. As illustrated, screws 306 may couple the cover 302 to the enclosure, which includes a mating portion for the screw 306, and SMM structures 304 may provide for removability of the cover 302 according to a temperature within the enclosure. Although a single screw 306 is illustrated, any number of screws may be utilized. As an example, the temperature within the enclosure may be determined by a heat generating component (not illustrated), such as a CPU, disposed within the enclosure.

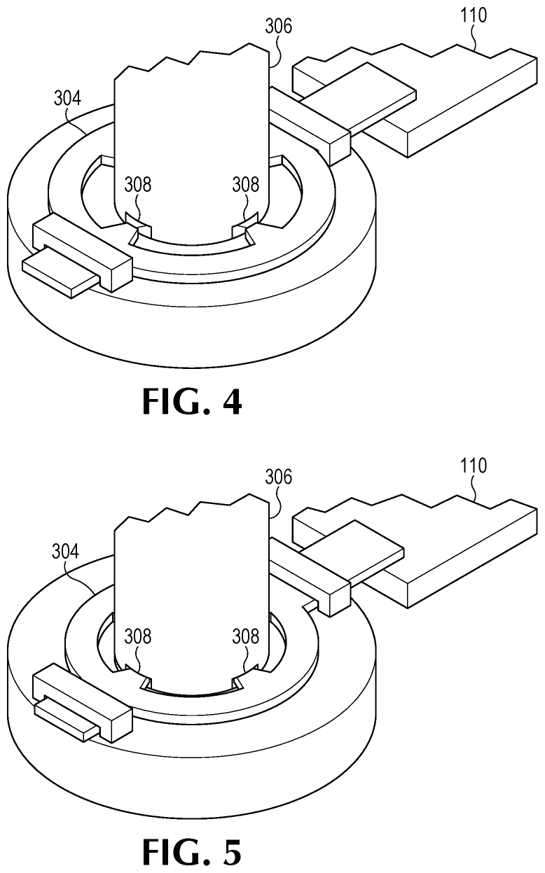

Similar to FIGS. 1-2, a thermally conductive component 110, such as a heat pipe, may couple the heat generating component (e.g., CPU) and the SMM structure 304. As a result, heat generated by the heat generating component may transfer to the SMM structure 304 via the heat pipe 110, triggering a resulting shape change of the SMM structure 304, as will be further described in FIGS. 4-5. As an example, when the temperature of the heat generating component is to exceed the threshold value, as described above, heat generated by the heat generating component may transfer to the SMM structure 304 via the heat pipe 110, and the SMM structure 304 may prevent removability of the cover 302, for example, by engaging cavities 308 within the screw 306. In addition, when the temperature of the heat generating component is to fall back below the threshold value, the SMM structure 304 may allow for removability of the cover 302, for example, by disengaging from the cavities 308.

FIGS. 4-5 illustrate adjustments made to the SMM structure 304 according to a temperature within the enclosure, according to an example. As an example, when the temperature of the heat generating component exceeds the threshold value or is at a higher temperature, indicating that the processing load of the CPU may be high, accessibility within the enclosure may not be desirable, for example, to avoid user injury. As a result, heat generated by the heat generating component may transfer to the SMM structure 304 via the heat pipe 110, triggering a resulting shape change of the SMM structure 304. For example, the SMM structure 304 may engage the cavities 308 within the screw 306, as illustrated in FIG. 5, thereby preventing a user from unscrewing screw 306. However, when the temperature of the heat generating component falls back below, or is below the threshold value, or at a lower temperature like room temperature, indicating that the processing load of the CPU may be low, the SMM structure 304 may adjust to allow for removability of the cover 302. As an example, the adjustment may include the SMM structure 304 expanding and no longer engaging the cavities 308 within the screw 306, as illustrated in FIG. 4, thereby allowing a user to unscrew screw 306 and remove cover 302.

It is appreciated that examples described may include various components and features. It is also appreciated that numerous specific details are set forth to provide a thorough understanding of the examples. However, it is appreciated that the examples may be practiced without limitations to these specific details. In other instances, well known methods and structures may not be described in detail to avoid unnecessarily obscuring the description of the examples. Also, the examples may be used in combination with each other.

Reference in the specification to “an example” or similar language means that a particular feature, structure, or characteristic described in connection with the example is included in at least one example, but not necessarily in other examples. The various instances of the phrase “in one example” or similar phrases in various places in the specification are not necessarily all referring to the same example.

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the scope of the disclosure. Thus, the present disclosure is not intended to be limited to the examples shown herein but is to be accorded the widest scope consistent with the principles and novel features disclosed herein.

What is claimed is:

1. An enclosure of a computing device comprising:
a cover to provide access to components within the enclosure, wherein the cover is coupled to the enclosure via a shape memory material (SMM) structure; and
a heat generating component disposed within the enclosure, wherein the SMM structure is to provide for removability of the cover according to a temperature of the heat generating component.

2. The enclosure of claim 1, wherein when the temperature of the heat generating component is to exceed a threshold value, the SMM structure is to prevent removability of the cover.

3. The enclosure of claim 2, wherein when the temperature of the heat generating component is to fall back below the threshold value, the SMM structure is to allow for removability of the cover.

4. The enclosure of claim 3, wherein the cover comprises a slot to accommodate the SMM structure.

5. The enclosure of claim 4, wherein, when the temperature of the heat generating component is to exceed the threshold value, a shape of the SMM structure is to adjust within the slot of the cover, preventing removability of the cover.

6. The enclosure of claim 3, comprising a screw to couple the cover to the enclosure.

7. The enclosure of claim 6, wherein, when the temperature of the heat generating component is to exceed the threshold value, a shape of the SMM structure is to adjust in order to prevent removability of the screw from the cover.

8. The enclosure of claim 1, comprising a thermally conductive component coupled to the heat generating component and the SMM structure.

9. The enclosure of claim 8, wherein heat generated by the heat generating component is to transfer to the SMM structure via the thermally conductive component, wherein adjustments to the SMM structure correspond to the heat transferred to the SMM structure.

10. An enclosure of a computing device comprising:
a cover to provide access to components within the enclosure, wherein the cover is coupled to the enclosure via a shape memory material (SMM) structure; and
a heat generating component disposed within the enclosure, wherein the SMM structure is to provide for removability of the cover according to a temperature of the heat generating component, wherein when the temperature of the heat generating component is to exceed a threshold value, the SMM structure is to prevent removability of the cover.

11. The enclosure of claim 10, wherein the cover comprises a slot to accommodate the SMM structure.

12. The enclosure of claim 11, wherein, when the temperature of the heat generating component is to exceed the threshold value, a shape of the SMM structure is to adjust within the slot of the cover, preventing removability of the cover.

13. An enclosure of a computing device comprising:
a cover to provide access to components within the enclosure, wherein the cover is coupled to the enclosure via a shape memory material (SMM) structure;
a heat generating component disposed within the enclosure, wherein the SMM structure is to provide for removability of the cover according to a temperature of the heat generating component; and
a thermally conductive component coupled to the heat generating component and the SMM structure, wherein heat generated by the heat generating component is to transfer to the SMM structure via the thermally conductive component, wherein adjustments to the SMM structure correspond to the heat transferred to the SMM structure.

14. The enclosure of claim 13, wherein when the temperature of the heat generating component is to exceed a threshold value, the SMM structure is to prevent removability of the cover.

15. The enclosure of claim 14, wherein when the temperature of the heat generating component is to fall back below the threshold value, the SMM structure is to allow for removability of the cover.
